(19) United States
(12) Patent Application Publication
(10) Pub. No.: US 2005/0002512 A1
(43) Pub. Date: Jan. 6, 2005

(54) Routing method

(76) Inventor: Armin Wilke, Ampfing (DE)

Correspondence Address: Siemens Corporation;Intellectual Property Department, 170 Wood Avenue South, Iselin, NJ, 08830, US

(21) Appl. No.: 10/497,260

(22) PCT Filed: Dec. 3, 2002
(86) PCT No.: PCT/DE02/04422

(30) Foreign Application Priority Data
Dec. 4, 2001 (DE) 101 59 435.6

(51) Int. Cl. H04M 7/00

(52) U.S. Cl. 379/220.01; 379/221.15

(57) ABSTRACT

The invention relates to a method for routing messages between virtual networks in a telecommunication network and to a suitable switching center for said method. According to the invention, signaling connections are set up between virtual networks using an internal signaling loop in a switching center in which virtual networks coexist. Internal signaling loop means that a logical connection has been established between the virtual networks in the switching center in the second and third levels of he message transfer part of the switching center but no physical connection in the first level of the message transfer part of the switching center. Hence, no additional hardware per virtual network is required for the connection.

### CROSS REFERENCE TO RELATED APPLICATIONS

This application is the U.S. National Stage of International Application No. PCT/DE02/04422, filed Dec. 3, 2002 and claims the benefit thereof. The International Application claims the benefits of German application No. 10159435.6 filed Dec. 4, 2001, both of the applications are incorporated by reference herein in their entirety.

### FIELD OF INVENTION

The present invention relates to a method for routing messages between virtual networks in a telecommunications network, and to a suitable exchange for said method.

### BACKGROUND OF INVENTION

Current telecommunications systems are largely based on Signaling System No 7 (SS7) which agrees modalities and information content of signaling between network nodes (exchanges) and is increasingly used in telecommunications networks.

The basis of Signaling System 7 architecture is the Message Transfer Part (MTP) which establishes a connection between two adjacent signaling points and ensures fail-safe transmission of control information between them. Overlaid on the Message Transfer Part are various user parts which set up “end-to-end” connections between the originating exchange and the destination exchange.

As a result of telecommunications market deregulation, different operators can offer their services in competition with one another on the telecommunications market, said operators being able to use the existing network infrastructure in order to save the costs of setting up a separate infrastructure. The networks of the individual operators are mapped onto the existing telecommunications network in the corresponding regions, with overlaps necessarily occurring. This means that in individual cases operators are obliged to e.g. share exchanges.

Telecommunications networks consist of a plurality of exchanges (nodes). To control the telecommunication networks, information or signaling can be transmitted between the exchanges in parallel with the actual user data (associated) or separately therefrom (quasi associated), a basic distinction being drawn between equipment from which signaling originates or terminates (signaling end point, SEP) and equipment used to connect signaling end points (signaling transfer points, STP and signaling links).

Each signaling point such as an exchange (node) is uniquely identified in the network by its own signaling point code (SPC). The exchanges forward incoming messages on the basis of routing tables in which all the possible destination signaling points and the signaling routes to be used are entered.

In order to protect providers sharing an area of the telecommunication network from misuse or manipulation of their networks through the shared and undifferentiable use of the signaling point code SPC, DE 19930116 A1 discloses how separate so-called virtual networks can be set up for the individual operators.

These virtual networks are completely separated from one another and provide the full functionality of a conventional network. The addresses within these fictitious networks are independent of one another and are autonomously administered by each network operator.

If communication between virtual networks is required, this is possible e.g. via a gateway in the area of User Level 4 (ISDN User Part ISUP, Signaling Connection Control Part SCCP) of the so-called transit switching equipment or using an external signaling loop (PCM system) between the relevant Message Transfer Part MTP in the signaling transfer point STP.

For security reasons the gateways (e.g. for STP traffic) between two virtual networks must be handled as if the networks in question were physically separate. This can be achieved by routing the signaling and possibly also the connection via a transit exchange, or by the relevant signaling transfer point STP routing the signaling back to itself via an external signaling loop (hardware loop).

Additional hardware (e.g. PCM system) is required for setting up an external signaling loop. However, this additional hardware increases the operator's costs and the space requirement of the overall switching unit.

### SUMMARY OF INVENTION

The object of the invention is to specify an exchange or a routing method with which a communication connection can be created between virtual networks without using an external signaling loop.

This object is achieved by the features set forth in the independent Claims, whereby signaling links are set up between virtual networks by means of an internal signaling loop in an exchange in which virtual networks co-exist. Internal signaling loop means that in the exchange a logical connection between the networks is set up at the second and third level of the Message Transfer Part of the exchange, but no physical connection between the networks at the first level of the Message Transfer Part of the exchange. Additional hardware per virtual network is no longer required for the connection.

If signaling links are set up from the virtual networks of the exchange to another exchange, the signaling traffic to the other exchange can be shared between the signaling links by means of the internal signaling loop and the bandwidth increased if necessary.

The invention is further developed by the features of the independent Claims.

### BRIEF DESCRIPTION OF THE DRAWINGS

The present invention will now be explained in greater detail with reference to the accompanying drawings in which:

FIG. 1 schematically illustrates the sequences of the method according to the invention in the Message Transfer Part MTP of the exchange,

FIG. 2 shows an example of a connection of two subscribers of an exchange who belong to different virtual networks, according to the invention,

FIG. 3 shows an example of increasing the bandwidth between exchanges by means of the exchange according to the invention, and

FIG. 4 shows virtual networks in a network section.

### DETAILED DESCRIPTION OF INVENTION

In Signaling System No. 7, each signaling point is uniquely identified by e.g. a 14-bit signaling point code. Each message contains both the signaling point code of the originating signaling point (originating point code, OPC) and of the destination signaling point (destination point code, DPC). Operating two SS7 nodes (exchanges) with the same signaling point code in one and the same MTP network is not possible according to the ITU-T (International Telecommunication Union) or ANSI (American National Standards Institute) standard.

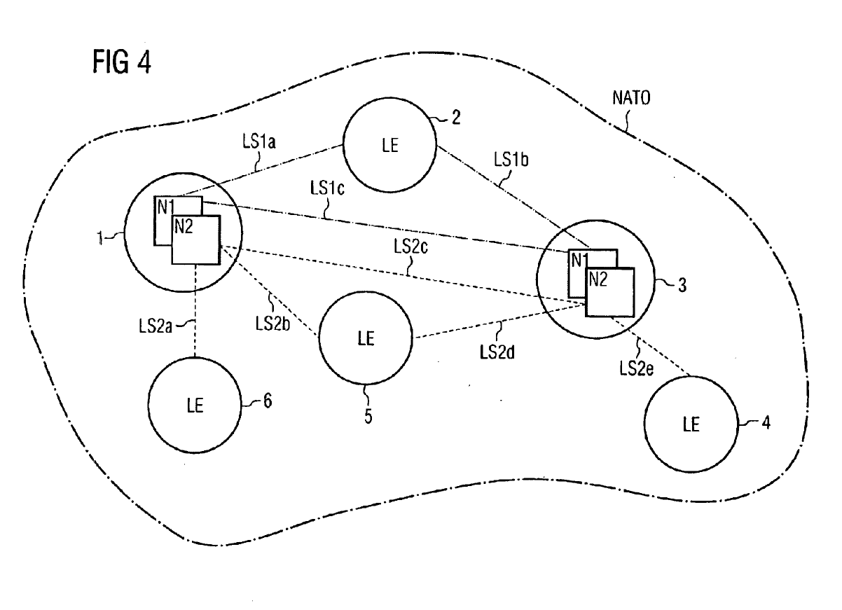

FIG. 4 shows a network section in which virtual networks as described in DE 19930116 A1 are set up in some exchanges 1-6. Virtual networks N1, N2 are set up only in the exchanges 1 and 3 with the same signaling point code (SPC) in the external network having the network indicator NAT0, whereas in the exchanges 2, 4, 5, 6 only one network (NAT0) is set up. The subscribers of the networks and the link-associated trunks between the exchanges 1-6 are not shown.

The exchanges 1-6 are connected using network-specific link sets LS. Viewed from the outside, all the link sets LS are assigned to the network NAT0. However, as seen by the exchanges 1 and 3, the individual link sets LS are assigned to virtual networks, i.e. the link sets LS1a . . . LS1c are assigned to the network N1 and the link sets LS2a . . . LS2e to the network N2. Between the exchanges 1 and 3, the link sets LS1c for the network N1 and LS2c for the network N2 exist within the external network NAT0.

To separate the two networks N1 and N2 in the exchanges 1 and 3, each virtual network N1, N2 is assigned an internal network number (network ID). Each incoming message from outside to one of the virtual networks N1 and N2 in the exchanges 1, 3 is associated with the relevant internal network number. Thus, for example, a signaling message sent from outside via the link set LS1a to the exchange 1 to set up a voice connection to a subscriber on the exchange 3 is associated in the exchange 1 with the internal network number of the network N1.

This can be performed e.g. by an input interface of the exchange 1 inserting the network identifier in a header of a signaling data block. The exchange 1 selects, on the basis of the identifier, the signaling point code SPC used for forwarding the message and detects, for example, that the message must be forwarded to the exchange 3. For said forwarding the exchange 1 selects the link set LS1c likewise assigned to the network identifier of the network N1.

Each exchange 1-6 has a signaling point code which only needs to be unique within its network. The individual exchanges 1-6 of a virtual network N1, N2 can only connect with one another by means of those exchanges 1-6 that are assigned to their network identifier.

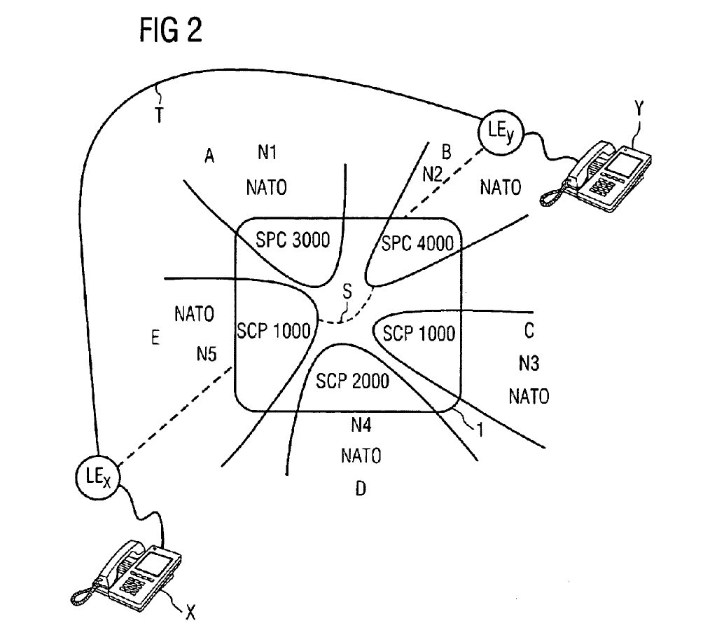

FIG. 2 shows a network NAT0 in which the operators A, B, C, D and E share the exchange 1. Each of the virtual networks N1 . . . N5 is autonomously administered by the telecommunications providers A . . . D separately and without affecting the other virtual networks.

Operator B and operator E agree that the subscribers X and Y of their respective networks N5 and N2 may communicate with one another. For this purpose a gateway for the signaling is set up by an internal signaling loop S between the two separate SS7 networks N2 and N5 in the exchange 1 and a communication connection T (trunk) is set up for voice transmission between the local exchanges LEₓ and LE_{y} of the subscribers X, Y.

For correct handling of the SS7 messages in the Message Transfer Part MTP, the corresponding SS7 routing data (route, route set, link, link set, etc.) is set up in the exchange 1. According to the invention, no physical SS7 data link is set up for the internal signaling loop S at MTP Level 1, i.e. at MTP Level 3 and MTP Level 2 a logical connection is set up between the virtual SS7 networks N2 and N5 in the exchange 1, but no physical connection at MTP Level 1.

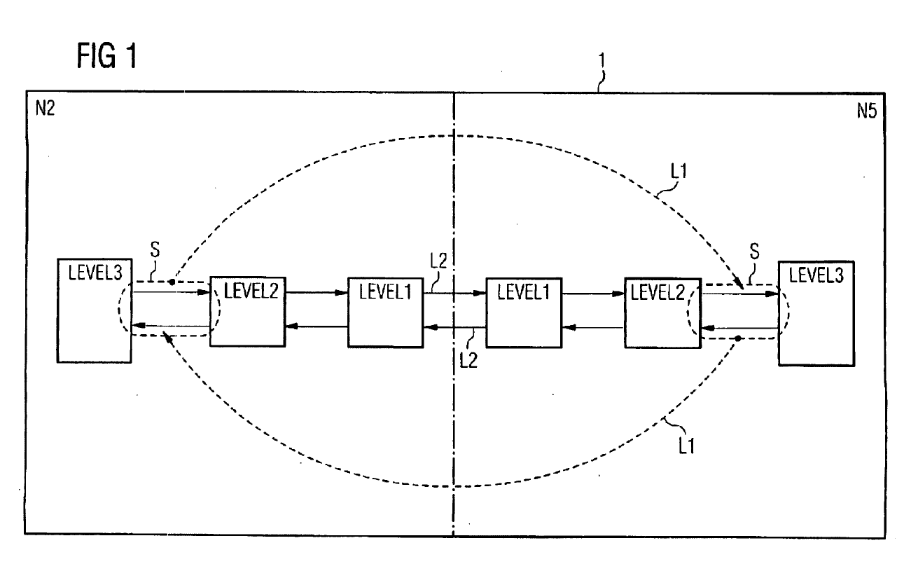

FIG. 1 shows the structure and the corresponding sequences in the Message Transfer Part MTP of the exchange 1. It may be seen that the SS7 link L1 which is to function as an internal signaling loop S is treated in the same way as a normal link that has been set up physically. Data is exchanged by means of the link L1 at Message Transfer Part Levels 3 and 2.

The SS7-relevant routing data (route, route set, link, link set, etc.) is set up in the known manner, the internal signaling loop S being set up by a special SS7 link L1 which is identified as “Link L1 without SS7 Data Link L2”. When setting up said SS7 link L1, the logical name of the SS7 link is additionally made known in the other virtual network N2 or N5 in each case, i.e. no physical connection L2 for data transmission of the signaling is switched by the exchange 1 for the communication of the subscribers X and Y. As no physical connection L2 relating to the logical connection L1 exists here, the link L1 is specifically identified.

The following example illustrates the setting up of the SS7 link for an internal signaling loop S between the networks N2 and N5 in the virtual network 1.

Setting up the SS7 link L1 in the virtual network N2:
CreateLink:
Name=iSigLoop1₁₃ N2;
SigLoop=TRUE;
LinkTermination=iSigLoop1 N5; LinkSet=LinkSetA;
Setting up the SS7 link L1 in the virtual network N5
CreateLink:
Name=iSigLoop1₁₃ N5;
SigLoop=TRUE;
LinkTermination=iSigLoop1₁₃ N2;
LinkSet=LinkSetB;

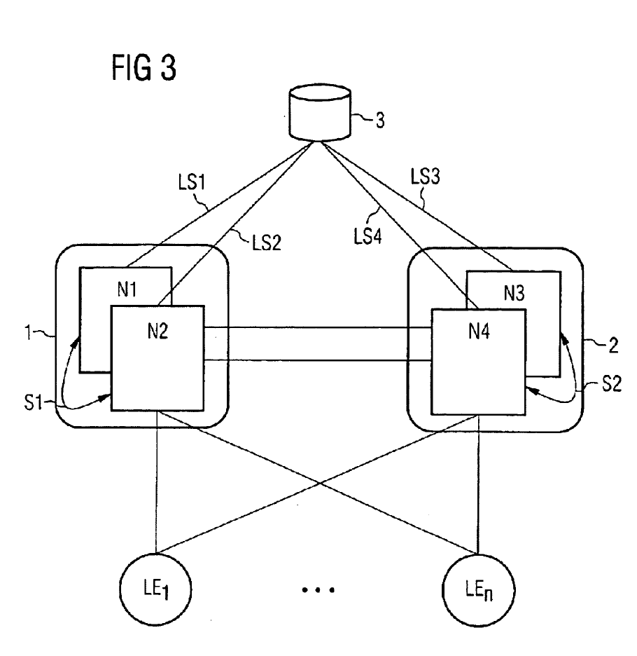

FIG. 3 shows an example of increasing the bandwidth of the connections between the exchange 3 (central database; e.g. SCP, HLR) and the exchanges 1 and 2 or the signaling transfer points STP preceding the local exchanges LE₁ . . . LE_{N}.

It shall be assumed that the signaling traffic caused by an increase in the data inquiries to the database 3 from the local exchanges LE₁ . . . LE_{N} can no longer be handled using one link set between the exchange 1 and the database 3 and the exchange 2 and the database 3 in each case. The networks N1 and N2 are set up in the exchange 1, and the networks N3 and N4 in the exchange 2, said networks being connected by means of internal signaling loops S1 and S2 respectively. The accumulated signaling traffic of the local exchanges LE₁ . . . LE_{N} can now be distributed over the link sets LS1 . . . LS4, provided that the local exchanges LE₁ . . . LE_{N} remain unaffected by this expansion.

To ensure that the signaling traffic (database inquiries to the database 3 and returning of results to the local exchanges LE₁ . . . LE_{N}) can be evenly distributed to the four link sets LS1 . . . LS4 now available, corresponding routes must be set up in the node exchanges 1 and 2. For example, in the virtual network N2 in the exchange 1 a second route is set up via the internal signaling loop S1 and the link set LS1 to the database 3 in addition to the originally available route LS2 to the database 3. Similarly, in the virtual network N4 in the exchange 2 a second route is set up via the internal signaling loop S2 and the link set LS3 to the database 3 in addition to the originally available route LS4 to the database 3. The signaling traffic is evenly distributed over the link sets LS1 . . . LS4 on the basis of data from the signaling traffic and settings in the exchanges 1 and 2.

The example shows that data transmission and signaling traffic between the exchanges 1 and 3 and 2 and 3 can be increased using the exchange according to the invention, with no corresponding virtual networks having to be set up in the partner exchange (database) 3.

1.-8. (cancelled)

9. An exchange in a telecommunications network, in which exchange at least two virtual networks co-exist, wherein at least one signaling link is set up within a second and a third level of a message transfer part of the exchange between two virtual networks of the exchange.

10. The exchange according to claim 9, wherein no physical connection is set up in respect of a signaling link between the virtual networks.

11. The exchange according to claim 9, further comprising:
a plurality of signaling links to another exchange, wherein
one signaling link is set up in each case from the virtual networks to the other exchange and wherein
the signaling traffic to the other exchange is distributed onto the signaling links to the other exchange by the signaling link between the virtual networks.

12. The exchange according to claim 10, further comprising:
a plurality of signaling links to another exchange, wherein
one signaling link is set up in each case from the virtual networks to the other exchange and wherein
the signaling traffic to the other exchange is distributed onto the signaling links to the other exchange by the signaling link between the virtual networks.

13. The exchange according to claim 9, further comprising:
a plurality of signaling links to another exchange, wherein
signaling links are set up within the exchange in different virtual networks, and outside the exchanges in one and the same network using a network indicator.

14. The exchange according to claim 10, further comprising:
a plurality of signaling links to another exchange, wherein
signaling links are set up within the exchange in different virtual networks, and outside the exchanges in one and the same network using a network indicator.

15. The exchange according to claim 11, further comprising:
a plurality of signaling links to another exchange, wherein
signaling links are set up within the exchange in different virtual networks, and outside the exchanges in one and the same network using a network indicator.

16. A method for routing messages between virtual networks in a telecommunications network, comprising:
providing an exchange having at least one virtual network; and
setting up signaling links within a second and a third level of a message transfer part of the exchange between the virtual networks of the exchange.

17. The method according to claim 16, wherein no physical connection is set up in respect of the signaling link between the virtual networks.

18. The method according to claim 16, further comprising:
setting up a signaling link to another exchange in each virtual network in the exchange; and
distributing the signaling traffic to the other exchange via the signaling links to the other exchange by the signaling link between the virtual networks.

19. The method according to claim 17, further comprising:
setting up a signaling link to another exchange in each virtual network in the exchange; and
distributing the signaling traffic to the other exchange via the signaling links to the other exchange by the signaling link between the virtual networks.

20. The method according to claim 16, further comprising:
providing a plurality of signaling links to another exchange; and
setting up the signaling links within the exchange in different virtual networks, and outside the exchanges in one and the same network using a network indicator.

21. The method according to claim 17, further comprising:
providing a plurality of signaling links to another exchange; and
setting up the signaling links within the exchange in different virtual networks, and outside the exchanges in one and the same network using a network indicator.

22. The method according to claim 18, further comprising:
providing a plurality of signaling links to another exchange; and
setting up the signaling links within the exchange in different virtual networks, and outside the exchanges in one and the same network using a network indicator.
